(19) United States
(12) Patent Application Publication
(10) Pub. No.: US 2016/0222333 A1
(43) Pub. Date: Aug. 4, 2016

(54) SYSTEM AND METHODS FOR THE COMPLETION OF CHEMICAL REACTIONS IN BOTTLED PRODUCTS

(71) Applicant: Larrian Gillespie, Los Angeles, CA (US)

(72) Inventor: Larrian Gillespie, Los Angeles, CA (US)

(21) Appl. No.: 15/010,191

(22) Filed: Jan. 29, 2016

Related U.S. Application Data
(60) Provisional application No. 62/109,518, filed on Jan. 29, 2015.

(51) Int. Cl. C12H 1/16; C12G 1/00; C12G 3/06; C12H 1/22; C12H 1/18

(52) U.S. Cl. CPC C12H 1/16; C12H 1/22; C12H 1/18; C12G 3/06; C12G 1/00

(57) ABSTRACT

A method of aging a post-bottled beverage. The method includes adding water to an ultrasound bath and placing the post-bottled beverage in the ultrasound bath. The water is at least one inch above the bottom of the bottle of the post-bottled beverage. The method also includes applying ultrasonic irradiation to the ultrasound bath at a frequency causing cavitation. The method further includes continuing the application of the ultrasonic irradiation for a duration sufficient for the cavitation to advance the aging process of the post-bottled beverage.

### CROSS-REFERENCE TO RELATED APPLICATIONS

This application claims the benefit of and priority to U.S. Provisional Patent Application Ser. No. 62/109,518 filed on January 29, 2015, which application is incorporated herein by reference in its entirety.

### BACKGROUND OF THE INVENTION

Post manufactured alcohols, especially wine, require a period of time for cellaring in order to slowly consume the oxygen in the bottle as a result of the bottling process. All the complex elements in wine (phenolics, tannins, aldehydes, esters and compounds) are constantly evolving, both on their own and in relation to each other. Once the oxygen has been consumed, the alcohol will display its flavor profile. This is a very inefficient method for revealing the flavor profile of wine. Re-exposing the alcohol to more oxygen by opening the bottle can result in acetic acid formation in wine and loss of the flavor volatile aroma compounds.

There are multiple methods used in an attempt to speed the aging process in alcohols. All of these methods are pre-bottling (maturation phase) and use a combination of direct or indirect ultrasonification. I.e., the liquid (alcohol) is in the tank and the sonic waves are processed through the liquid either in line by placing an ultrasonic horn directly in the liquid or in a tank. Other methods attempt to remove the residual sulfite gas in wine by degassing or opening the system, but in doing so, also remove the aromatics which have developed in the alcohol, specifically wine, as there is no separation process for retaining the aromatics.

Accordingly, there is a need in the art for a technique that would produce a consistent, stable alcohol post bottling in order to extend shelf life and to result in a uniform flavor and aroma profile. Further, there is a need in the art for the method to avoid removing aromatics. Moreover, there is a need in the art for the method to avoid direct sonfication.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of aging a post-bottled beverage. The method includes adding water to an ultrasound bath and placing the post-bottled beverage in the ultrasound bath. The water is at least one inch above the bottom of the bottle of the post-bottled beverage. The method also includes applying ultrasonic irradiation to the ultrasound bath at a frequency causing cavitation. The method further includes continuing the application of the ultrasonic irradiation for a duration sufficient for the cavitation to advance the aging process of the post-bottled beverage.

Another example embodiment includes a method of aging a post-bottled beverage. The method includes adding water to an ultrasound bath and placing the post-bottled beverage in the ultrasound bath. The water is at least one inch above the bottom of the bottle of the post-bottled beverage. The method also includes applying ultrasonic irradiation to the ultrasound bath at a frequency causing cavitation. Applying ultrasonic irradiation includes operating the ultrasound bath in a pulse mode for approximately two minutes. Applying ultrasonic irradiation also includes operating the ultrasound bath in a sweep mode for approximately twenty minutes and at a frequency of between 35 kHz and 45 kHz. The method further includes heating the water to a temperature of between 35°C. and 65°C. while applying ultrasonic irradiation.

Another example embodiment includes a method of treating a post-bottled beverage. The method includes opening the post-bottled beverage, adding an additive to the post-bottled beverage and closing the post-bottled beverage. The method also includes adding water to an ultrasound bath and placing the post-bottled beverage in the ultrasound bath. The water is at least one inch above the bottom of the bottle of the post-bottled beverage. The method further includes applying ultrasonic irradiation to the ultrasound bath at a frequency causing cavitation. The method additionally includes continuing the application of the ultrasonic irradiation for a duration sufficient for the cavitation to advance the aging process of the post-bottled beverage.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flow chart illustrating an example of a method for completion of chemical reactions in a bottled beverage;

FIG. 2 is a flow chart illustrating an example of a method for treating a bottled beverage;

FIG. 3A shows an ultrasound bath; and

FIG. 3B shows a close-up view of the ultrasound bath;

FIG. 4 illustrates an example of glycerol levels (value 16.93) for a post-production/bottled pinot noir that is untreated and

FIG. 5 illustrates an example of glycerol levels after ultrasonification in the same post-production/bottled pinot noir.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

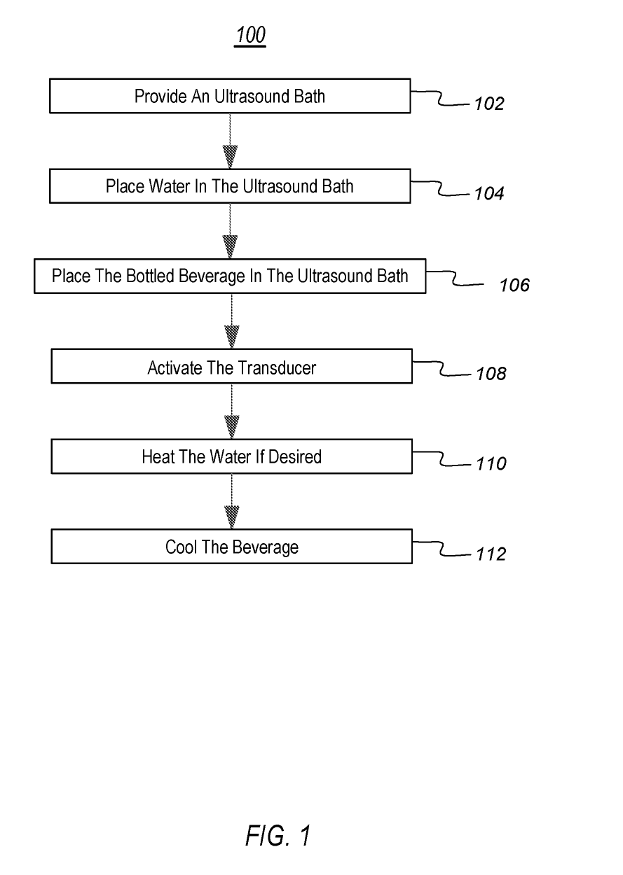

FIG. 1 is a flow chart illustrating an example of a method 100 for completion of chemical reactions in a bottled beverage. As used herein, the term “maturation” is used for the changes during bulk storage and the term “aging” is used for the changes during bottle storage. Thus, maturation is exclusively pre-bottling and aging is exclusively post-bottling. The key difference is that during bulk storage a wine or distilled spirit is likely to be exposed to air where as in bottled it is stored in essentially anaerobic conditions. However, many references use these terms incorrectly as defined herein (e.g., they use the term aging for pre-bottling processes). Some alcohols, such as wine mature and age while others, particularly distilled alcohols, such as vodka, mature but do not age. That is, the chemical composition of wine changes both before and after bottling whereas whiskey undergoes changes in chemical composition only prior to bottling and chemical composition is unchanged after bottling. The method 100 as disclosed herein is exclusively for aging a bottled product.

Therefore, as used herein wine aging refers to a group of reactions that tend to improve the taste and flavor of a wine over time. The term wine ‘maturation’ refers to changes in wine after fermentation and before bottling. The term aging should be reserved to describe changes in wine composition after bottling. After bottling, once the oxygen picked up at bottling is consumed, the wine is in the absence of oxygen. This is called the reductive atmosphere. Many reactions occur during this phase to contribute to the final bottle bouquet.

In contrast, alcoholic spirits are matured in barrels and do not undergo aging. A 12-year-old Scotch is therefore matured for 12 years in a barrel, then bottled but cellaring the distilled spirit will have no further effect on the flavor profile. Thus, one would not expect any changes to the composition of distilled spirits that are bottled for consumption as all chemical reactions should be complete. However, like wine, the master distiller or the wine maker are constantly battling temperature. It must be high enough to create chemical reactions but low enough to prevent evaporation. This leaves incomplete chemical reactions, especially in distilled spirits, which could improve the flavor profile.

FIG. 1 shows that the method 100 can include providing 102 an ultrasound bath. The ultrasound bath includes any device which is capable of ultrasonic treatment of an external object. For example, the ultrasound bath can include a chamber for receiving the external object and a treatment solution, a basket or container for keeping the external object away from the bottom of the chamber (objects must not be allowed to rest on the bottom of the device during the sonication process, because that will damage the transducer(s)), a transducer for producing the ultrasound waves, various controls for adjusting the pattern and/or frequency of the ultrasound, and any other desired elements for creating ultrasonification. Likewise, the ultrasound bath can include a heater to allow for thermal treatment of the external object if desired.

Ultrasonification is the process of treating the bottled beverage in an ultrasound bath to decrease the time required for the beverage to age or to complete residual chemical reactions in matured distilled spirits. In an ultrasound bath, the object to be treated is placed in a chamber containing a suitable solution (in an aqueous or organic solution, depending on the application). An ultrasound generating transducer built into the chamber, produces ultrasonic waves in the fluid by changing size in concert with an electrical signal oscillating at ultrasonic frequency. This creates compression waves in the bottled liquid which ‘tear’ the liquid apart, leaving behind many millions of microscopic ‘voids’ or ‘partial vacuum bubbles’ (cavitation). These bubbles travel at speeds faster than a lightning strike, generate more pressure than the bottom of the ocean (about 1000 atmospheres), achieve temperatures higher than the surface of the sun (about 5000K) and heating and cooling rates above 10¹⁰ K/s. The higher the frequency, the smaller the nodes between the cavitation points.

Cavitation produces a shearing mechanism resulting in the production of heat. This process also applies energy to electrons causing the creation of nanoparticles. Ultrasonic irradiation, through a process called sonocatalysis, smooths, at a macroscopic scale, the initially crystalline surface of unsaturated organic compounds and causes agglomeration of small particles by increasing their catalytic activity. Applying ultrasonic energy for too long results in the Ostwald ripening effect, in which particle to particle aggregation and fusion occurs. This creates a coarseness and change in color (darkening). This is akin to the formation of larger ice crystals in ice cream instead of smaller, smoother crystals. All known techniques require a prolonged exposure to ultrasonic waves, as much as one to several days, which results in particle to particle aggregation and a “sterile” aroma as all volatiles are removed from the degassed solution.

Utilizing an open tank system or bottle in which the alcohol is exposed to oxygen leaves an air/solution interface which does not produce homogenous cavitation near the transducer, as demonstrated by existing sonochemiluminescence (SCL) images. In particular, the images show that mixing in open containers undergo far less efficient mixing than closed containers. For example, ultrasonification using a frequency of 647 kHz at a power of 60 Watts for two minutes results in almost complete mixing with a closed container while the same treatment results in only partial mixing with an open container. This difference may be due to the changes in traveling and standing wave components, which seems to be an important factor at higher frequencies.

FIG. 1 also shows that the method 100 can also include placing 104 water in the ultrasound bath. The water can include tap water or distilled water. The water should not exceed the fill level of the tank but should be sufficient to cover the beverage container(s) to at least one inch from the bottom. The water allows for indirect ultrasonification of the beverage within the closed bottle. Additionally or alternatively, the water is necessary to provide more even heating to the beverage. I.e., the water undergoes heating and ultrasonification with the energy being transferred to the beverage which can remain in a separate container. After treatment occurs the water is uncontaminated and can be used again, either for treatment of other bottled beverages or for any other purpose.

FIG. 1 additionally shows that the method 100 can include placing 106 the bottled beverage in the ultrasound bath. The water should be at least one inch above the bottom of the bottle and the bottle should not touch the chamber. The beverage to be treated with ultrasonification can include any post-bottled beverage. For example, the beverage can include an alcoholic beverage, such as wine or distilled spirit. This technique is applicable to any alcohol containing sugar, preferably glucose, which converts the glucose to glycerol resulting in an improved, pleasing taste and texture with less effect on blood insulin along with prolonged shelf stability. It can be performed in any size tank with the appropriate number of piezoelectric transducers to create a uniform irradiation pattern in the tank and can treat as many bottles as the tank can hold.

Alcohols that have finished their processing and are bottled, or alcohols that are mixed together and bottled can be treated using ultrasonification. Therefore, all aromatics, gases, etc. are contained in the bottle, including a headspace that contains oxygen. Maturation refers to changes in alcohols after fermentation or distillation and before bottling. Aging describes changes in alcohol composition after bottling. The normal process of aging of an alcohol is to allow for the slow consumption of oxygen as it reacts with the sugars to complete, in a passive manner, the formation of new chemical bonds. This is known as the reductive phase, meaning oxygen is consumed. Affinage is the “bringing to age” of any process. In cheese, the affineur takes the finished product from the cheesemaker, and now applies other techniques to enhance the characteristics of the particular cheese by washing, turning, applying alcohols, humidity or dryness to the cheese to increase the flavor and texture of the final product. Likewise, the method 100 is an affinage technique for alcohols which brings the chemical elements to their full potential in much less time.

Bottle shock or bottle sickness is a temporary condition of wine characterized by muted or disjointed fruit flavors. It often occurs immediately after bottling or when wines (usually fragile wines) are given an additional dose of sulfur (in the form of sulfur dioxide or sulfite solution), and are subject to other forms of handling and transport. Sonication of wines post bottling prevents this process because rheologic new compounds are formed and completed, allowing transportation and handling to have little or no effect on the stability of the wine.

The water level in relation to the beverage container can be critical to obtaining the desired result (aging of the bottled beverage). With a water level below one inch a vertical jet stream is created in the beverage, which assists the aging process, as described below.

FIG. 1 moreover shows that the method 100 can include activating 108 the transducer. Activating 108 the transducer results in indirect ultrasonification of the beverage. Ideally, the transducer is built into the chamber and not placed in the water. For example, an ultrasound bath can be utilized with a piezoelectric transducer of no less than 25 kHz up to 85 kHz, with the preferred range being 35-45 kHz, specifically and ideally approximately 35 kHz. The ultrasonification can occur for a period of 15-25 minutes with the preferred time being approximately 20 minutes. The bath has an intensity above 1 W/cm squared. The unit has a minimum of 120 watts of power, but preferably and ideally 150 watts. This is defined in the literature as high power ultrasound. A fixed ultrasonic power is best, used in the sweep mode (which may occur after a period of pulse mode—for approximately two minutes—to aid in degassing the liquid in the tank). Sweep creates acoustic streaming. The water vapor that collects in the neck of the bottle and drips back into the alcohol helps to release the adhesion of aromatic esters from alcohol allowing further reactions to occur. When operating in sweep mode, the ultrasonic frequency is modulated slightly above and below the central frequency, typically ±1-4 kHz. Ultrasonic sweep mode “sweeps” multiple ultrasonic frequencies through a single ultrasonic tank. This sweeping controls the creation of standing waves, allowing no single frequency to resonate in the tank, eliminating the root cause of standing waves, and tank dead spots. Whereas pulse mode is defined as intermittent high-intensity bursts, or peaks, of ultrasonic power to 600 W or 450 W more than the unit's effective power. “Sweep” provides a homogeneous distribution of ultrasonic energy throughout the bath to avoid what are called “standing waves” or areas of relatively high and low ultrasonic energy. Sweep works best on water-soluble and water-swollen particles. As used in the specification and the claims, the term approximately shall mean that the value is within 10% of the stated value, unless otherwise specified.

Alcohols are formed from catabolism of glucose and amino acids present in the mash or wash and have higher boiling points than that of ethanol. In all alcohols that contain residual glucose (C₆H₁₂O₆) and oxygen after bottling, a reaction occurs when a catalyst is applied which results in the formation of water (H₂O), CO₂ gas and energy, which is in the form of heat. This is the important change in the beverage as it ages and is known as the process of respiration. The more sugar and oxygen present in a bottled alcohol, the greater the respiration that can occur, resulting in a mature, pleasing taste and aroma of the alcohol. During the process, gases are released from the liquid which are trapped under the cork or cap, resulting in a compressed gas which in turn applies more pressure to the contained solution. According to Henry's Law, as the partial pressure increases under the cap by the production of CO₂, which is a heavier gas than O₂, more of the residual O₂ is forced back into the liquid where it reacts with the glucose in the solution creating CO₂, H₂O and heat. Water vapor collects in the neck of the bottle as well as CO₂.

Of the total energy which enters a system of this type, some is converted to heat in the piezoelectric material, some may be converted to heat in the liquid, and the remainder is consumed at the liquid surface in the process of breaking away particles to form the water vapor. Since bottles are never “topped off” but instead have a small but measureable volume of oxygen between the liquid and the cap. The sweep mode is applied for no less than 10 minutes and not to exceed 30 minutes in order to maintain uniform nanoparticle monodispersion and formation and prevent the particle to particle adhesion that occurs with longer exposure to ultrasonic irradiation which results in a polydispersed solution due to increasing size of the particles. Ultrasonic treatment at a higher kHz (e.g., 25 kHz) results in rapid growth of nanocrystals and polydispersion. In other words, there is an appropriate and optimal sonication time and energy level for the method 100.

FIG. 1 also shows that the method 100 can include heating 110 the water if desired. Heating 110 of the water results in indirect heating of the beverage. Heat is applied to increase the mobility of electrons and to decrease the surface tension by making alcohol more volatile. For example, the temperature of the water bath can set between 35° C. (95° F.) to 65° C. (130° F.), with the ideal at 55° C. At the end of sonication, the average temperature of the contained alcohol is 32° C. (90° F.), well below the 74° C. (165.2° F.), at which volatiles are destroyed in alcohols. This process increases the shelf life of open alcohols without the need for argon gas blankets, NO₂ gas or special sealing devices as the oxygen left in a bottle once opened and partially consumed, cannot react with the alcoholic elements to produce acetoaldehyde as they are all in a new rheologic, more stable format which would require extreme energy to break the new bonds of the nano particles which have formed. The alcohol now has a prolonged shelf life after opening due to the sonoluminescence generated by the collapsing bubbles which give off ultraviolet light, destroying residual yeast, mold and bacteria. As an example, wine sonicated in this manner, opened and half emptied, leaving room for oxygen, recorked and left at room temperature, was tested again at 24 days with no discernible difference in aroma, flavor or texture.

FIG. 1 further shows that the method 100 can include cooling 112 the beverage. Once the ultrasonic irradiation (and heat if applied) is terminated, the bottle is allowed to cool to room temperature, allowing the volatile aromatics to rediffuse back into the alcoholic solution in a new, aged form. Cooling 112 can occur in the ultrasound bath or by storing the bottled beverage in a normal manner (such as in a wine cellar or on a shelf). The headspace is now filled with compressed, inert CO₂ and other gases, but the oxygen has been consumed so no further respiration (maturation) can occur. The bottle is now inert for any further chemical reactions. In other words, treatment post bottling “finishes” the alcohol's normal aging. The residual CO₂ is compressed, making it an inert gas ideal for prolonging the shelf life of the bottled alcohol mixture, just as in alcohols that age “naturally” without the ultrasonification process. Once opened, the rheological changes make the alcohol impervious to the effects of oxygen resulting in a stable alcohol.

This process minimizes oxidative changes and browning in phenols, resulting in color stability. Ultrasonic treatment replaces the monomeric anthocyanin pigments with the polymeric form, which results by the combination of anthocyanin pigments with tannins. Oxygen is important in the condensation reaction between anthocyanins and tannins, which results in the gradual loss of free anthocyanins and the formation of stable polymeric (anthocyanin tannin) pigments. The condensation reaction between anthocyanins and tannins is accelerated by oxidation with the participation of acetoaldehyde. When taken to the full extreme, precipitation of these elements occurs. Polymerization of phenolic compounds results in a reduction in titrateable acidity and an increase in pH. Bitterness can be attributed to monomeric flavonoids. As flavonoid phenols polymerize they become less bitter and more astringent. With further polymerization the molecules become too large and precipitate, following the Ostwald principle previously discussed. This results in an alcohol with reduced astringency and a smoother, softer taste. Decreased titratable acidity is due to acid precipitation and ester formation. Acidity enhances astringency, and loss of acidity makes alcohols taste mellower. During aging, many esters are hydrolyzed and new esters form. Terpenes are converted to free volatile terpenes during aging.

The rate of oxidation in alcohols depends on pH, temperature, concentration of dissolved oxygen and the phenolic composition. Increased temperature accelerates the aging process. As noted, the medium temperature achieved was 90° F., which is well below the temperature at which volatile esters, terpenes and other volatile components are destroyed.

Ultrasonic irradiation differs from traditional energy sources (such as heat, light, or ionizing irradiation) in duration, pressure, and energy per molecule. Because of the immense temperatures and pressures and the extraordinary heating and cooling rates generated by cavitation bubble collapse, ultrasound provides an unusual mechanism for generating high energy chemistry. As in photochemistry, very large amounts of energy are introduced in a short period of time, but it is thermal rather than electronic excitation. High thermal temperatures are reached. Furthermore, sonochemistry has a high pressure component due to the cavitation effect. When a liquid is subjected to ultrasound, not only does chemistry occur, but light is also produced. Ultraviolet light is known to affect aging in alcohols by initiating an oxidative reaction. Studies of single bubble (SBSL) and multi-bubble (MBSL) sonoluminescence reveal that the origin of extreme intrabubble conditions is related to nonequilibrium plasma formed inside the collapsing bubbles. At high frequency ultrasound the plasma inside the collapsing bubbles exhibits Treanor behavior (anharmonic vibration-to-vibration pumping mechanism) typical for strong vibrational excitation. The photons and the “hot” particles generated by cavitation bubbles enable the excitation of nonvolatile species in solutions increasing their chemical reactivity. Secondary sonochemical products may arise from chemically active species that are formed inside the bubble but then diffuse into the liquid phase and react with solution precursors to form a variety of products. The irradiation from ultrasonic treatment of alcohols can speed up the aging process through numerous pathways.

This process is also “green” as it uses much less electricity than in-line systems, the water remains clean for much longer and needs less changing as no elements are contaminating the water and the minimum volume means less water is required for each run. This is a cost effective process.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

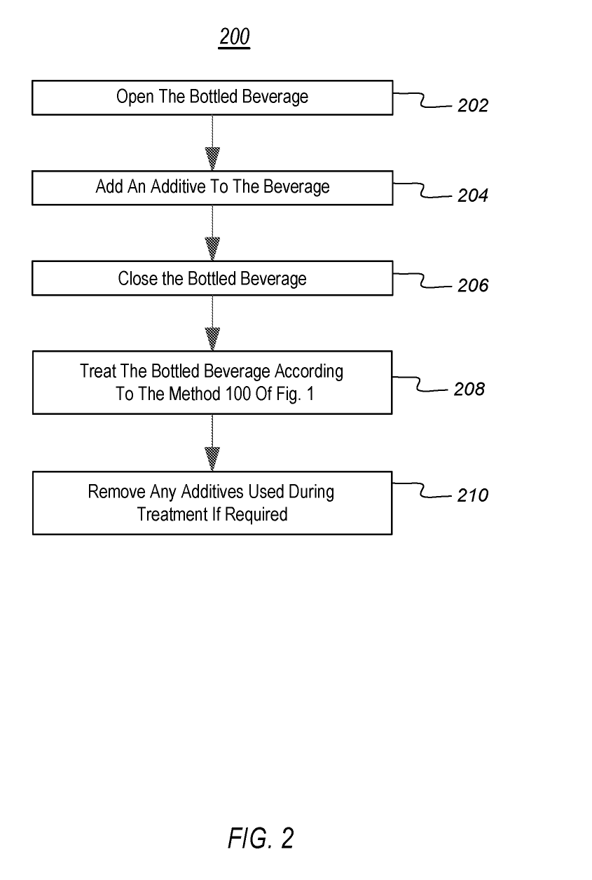

FIG. 2 is a flow chart illustrating an example of a method 200 for treating a bottled beverage. Treating the beverage can include adding color or flavoring to the beverage. The method 200 can be used on beverages which don't age, such as whiskey, or which have already been aged, either through the passage of time or using the method 100 of FIG. 1.

FIG. 2 shows that the method 200 can include opening 202 the sonicated bottled beverage. The cap, cork or other lid is removed exposing the beverage to air. Since the beverage is already aged to completion, it is stable in the air with exposure to oxygen. Therefore, opening 202 the bottle does not harm the beverage.

FIG. 2 also shows that the method 200 can include adding 204 an additive to the beverage. For example, the additive can include additional ingredients required for a cocktail. Additionally or alternatively, the additive can include anything that will add color or flavoring to the beverage. Adding 204 the additive can include inserting a bag containing herbs, wood pieces, spices or other flavoring or coloring elements. The bag is suspended within the bottle using a silicone band or other mechanism and the bottle is recapped. Further, the additive can include incorporating and dispersing powdered elements or to extract color from natural food elements, such as saffron, beets, cabbage, paprika, annatto, tumeric, carrot, black carrot, radish, purple sweet potato, ginger, extracts, essential oils, essences, distillates, resins, gums, balsams, juices, botanical extracts, flavor, fragrance, and aroma ingredients including essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products to name a few. In this instance, the element to be extracted is placed within a porous bag such as a tea bag or muslin or cheesecloth and placed within the beverage.

FIG. 2 further shows that the method 200 can include closing 206 the bottled beverage. For example, the bottle can be recapped or recorked or otherwise sealed before treating with ultrasonification.

FIG. 2 additionally shows that the method 200 can include treating the bottled beverage according to the method 100 of FIG. 1. For example, after the cap is applied and the product is placed in a non-heated or heated water bath between 35° C. and 65° C., it can be sonicated for no more than 30 minutes to achieve maximum extraction and coloring from powders or liquids by maintaining nanoparticle formation. So complete is this process that alcohols colored and flavored with saffron were still color and flavor stable (a brilliant orange instead of pale yellow) with no precipitation at six months. Without ultrasonification it is known that just instilling these ingredients into alcohol requires 1 to 3 weeks for partial extraction to occur, and then stability is limited to 72 hours before degradation begins to occur.

Similarly, powders can be mixed into post bottled alcoholic solutions using a power of 35 kHz set to the pulse or sweep mode. The technique is the same as above but the powder is applied directly to the alcohol. This results in microencapsulation and stability by preventing reagglomeration. Possible powders include spices, herbs, and sweeteners.

Cocktails may be premixed in this manner with prolonged shelf stability and improved integrated flavors and texture. For example, the ingredients for a Manhattan (rye whiskey, simple syrup, vermouth) can be bottled in desired proportions and capped, then sonicated and stored, having the same effect as days, weeks or a year or more of aging, as oxygen has been consumed and the remaining headspace has been replaced with compressed CO₂ from the respiration process. Again a heated bath between 35° C. and 65° C. is used and timed for a minimum of 10 minutes.

FIG. 2 additionally shows that the method 200 can include removing 210 any additives used during the treatment if required. I.e., if a bag was placed in the beverage then the bag is removed and the bottle is recapped. Because the beverage is stable after cooling, opening the bottle at this juncture does not harm the beverage.

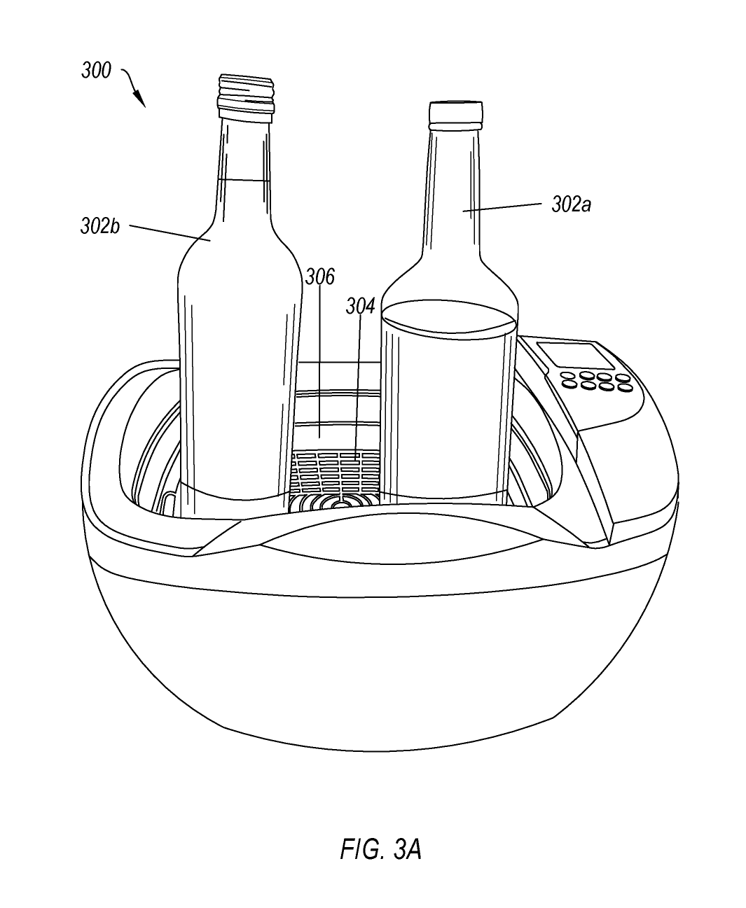

FIGS. 3A and 3B (collectively “FIG. 3”) illustrate an example of an ultrasound bath 300. FIG. 3A shows the ultrasound bath 300; and FIG. 3B shows a close-up view of the ultrasound bath 300. A first bottled beverage 302a and a second bottled beverage 302b (collectively “bottles 302”) have been placed in the ultrasound bath on a liner 304 that keeps the bottle from contacting the bottom of the ultrasound chamber and not obstructing or covering the transducer. The room temperature bottles 302 are ideally suspended ¼-inch from the bottom of the tank and do not need to be totally immersed. Bottles can be immersed in as little as 1-inch of water 306 or up to just below the maximum fill mark on the chamber. The transducer is not in the water but underneath the tank. The bottles 302 are upright in order to direct the acoustic stream of electrons upward towards the cork or cap during ultrasonic irradiation. Microjets are created by the electron tunneling under ultrasonic irradiation, and they rise up to the surface of the alcohol. When cavitation occurs in a liquid near a solid surface, the dynamics of cavity collapse changes dramatically. In pure liquids, the cavity remains spherical during collapse because its surroundings are uniform. Close to a solid boundary, however, cavity collapse is very asymmetric and generates high speed jets of liquid. These jets hit the surface with tremendous force.

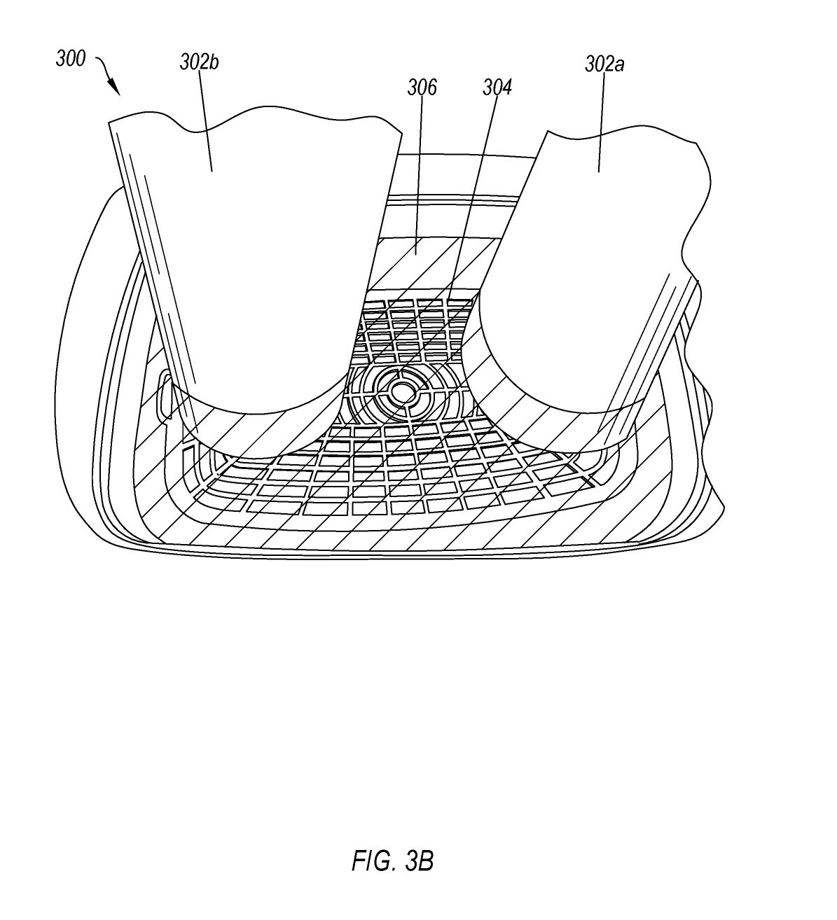

FIG. 4 illustrates an example of glycerol levels 400 for a bottle of post-production/bottled pinot noir or what you can buy in a store. The peak 402 of 16.93 is glycerol and the value is 18.

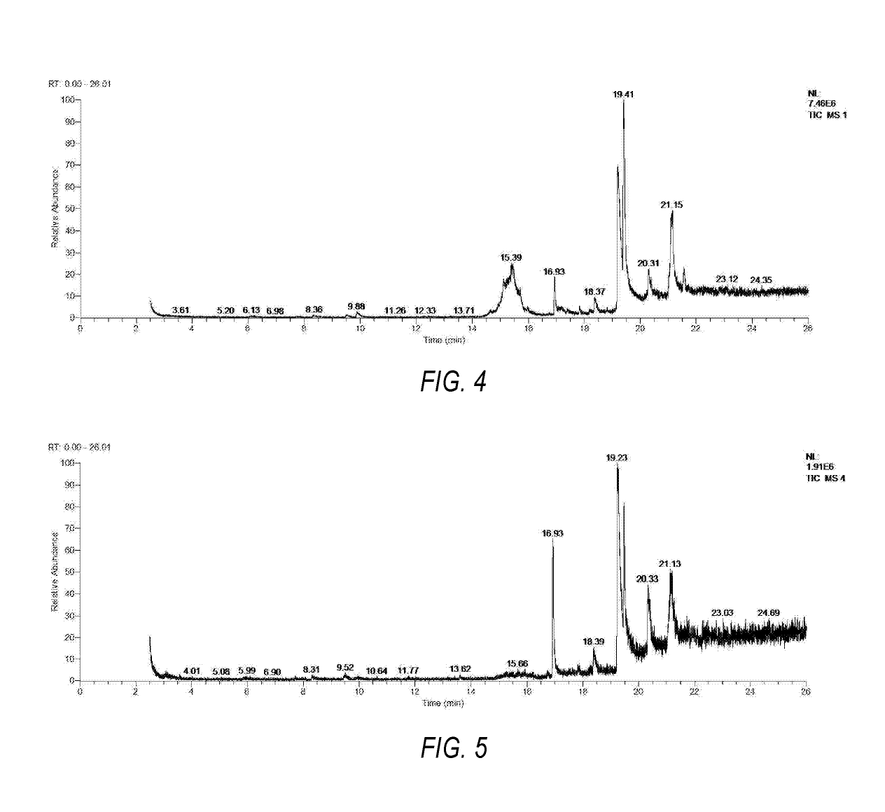

FIG. 5 illustrates an example of glycerol levels after 20 minutes sonication 500 in post-production/bottled pinot noir. The peak 402 of 16.93 is now almost quadrupled in value (78) and the number of aromatics has doubled. Glucose is converted to glyceraldehyde-3-phosphate and dihidroxyaceotone phosphate during fermentation of yeast. The phosphate converts to glyceraldehyde-3-phosphate, which produces ethanol and the rest converts to glycerol (C₃H₈O₃). In the process of this invention, it is presented that forced respiration can occur in the bottle if sonicated under a closed environment. Glucose plus oxygen=H₂O+CO₂+energy. Increased levels of glycerol were found in direct proportion to the time of sonication as evidenced by these GC/MS results of a pinot noir. After 5 minutes of sonication according to the method described, the glycerol levels rose. After 10 minutes of sonication there was a dramatic increase in glycerol levels and they continued to rise up to 20 minutes. As there is no fermentation from yeast occurring as this is a finished, produced bottle of pinot noir, the presence of increasing levels of glycerol must be produced from forced respiration and consumption of glucose and oxygen in the wine.

Table 1 shows analysis results from wine treated using the above method of aging. In Table 1, sample 1 was pinot noir unsonicated, sample 2 was pinot noir sonicated for 5 minutes, sample 3 was pinot noir sonicated for 10 minutes and sample 4 was pinot noir sonicated for 20 minutes. The analysis compared the relative composition trends of 5 of the most common non-solvent molecule peaks native to all 4 samples. These trends illustrate an increase in the hydrolysis of fats/oils, as shown by increased glycerol level, and a shift in the aromatic profile, as shown by changes in vanillin isomer proportions and an increase in benzyl benzoate. Vanillin comes from the oak and ethyl vanillin converts to vanillin during oxidation, the process which is sped up with ultrasonification. The disappearance of levels of isomer 1 is due to that conversion and the decreased values of ethyl vanillin and increased vanillin support this. The increased benzyl benzoate, which delivers a sweet balsamic flavor shows the mechanical aspect of ultrasonic treatment, not enzymatic, cleaving carbon chains and making more, tighter, stable compounds.

TABLE 1

| Common Peaks | Sample 1 | Sample 2 | Sample 3 | Sample 4 |
|---|---|---|---|---|
| Glycerol | 2.33 | 2.24 | 9.88 | 11.58 |
| Ethyl vanillin | 3.08 | 0.96 | 0 | 0 |
| Isomer I | | | | |
| Isomer II | 34.23 | 16.31 | 18.73 | 8.79 |
| Vanillin | 42.72 | 59.13 | 56.57 | 54.52 |
| Benzyl Benzoate | 2.35 | 10.26 | 8.97 | 9.6 |

Where all measurements are of relative percentage

Table 2 shows analysis results from whiskey treated using the above method of aging. In Table 2, untreated meant as it comes from the bottle without sonification, treated meant ultrasonification (“both samples” is “yes” if the result was unchanged from untreated to treated and “no” if the result is different in the treated sample vs. the untreated sample). Analysis compared the presence of 15 trace flavor components between the two samples. Of the 15 trace components, 12 were found to be mutually exclusive. Using these 12 mutually exclusive molecules, three main chemical reaction trends connecting the “Untreated” and “Treated” samples were ascertained: isomerization, shorter carbon chain derivatization, and bacterial lysis. Isomerization of flavor molecules was shown by the presence of Pentanol in the “Untreated” sample shifting to Iso-Pentanol in the “Treated” sample. Derivatization was supported by the presence of Hydroxy-Dodecanoic Acid in the “Untreated” sample shifting to Dodecanoic Acid, Octadecanoic Acid, and Methyl Ester Octadecanoic Acid in the “Treated” sample. Finally, lysis of residual bacterial (due to the cavitation giving off UV light) was hypothesized to explain the presence of Muramic Acid in the “Treated” sample, but absent in the “Untreated” sample. An increase in perceived sweetness due to the creation of arabinose (a low glycemic sugar created in the Wohl degradation process) was also noted.

TABLE 2

| | | Treated | |
|---|---|---|---|
| Molecule | Untreated Sample | Sample | Both Samples |
| Ethyl Acetate | No | Yes | No |
| Pentyl Acetate | Yes | No | No |
| Hydroxy Acetic Acid | Yes | Yes | Yes |
| Glycoaldehyde (dimer)/ | Yes | Yes | Yes |
| Hydroxy Aldehyde | | | |
| (monomer) | | | |
| Ethanol | Yes | Yes | Yes |
| Propanol | No | Yes | No |
| Pentanol | Yes | No | No |
| Iso-Pentanol | No | Yes | No |
| Dodecanoic (Lauric) Acid | No | Yes | No |
| Hydroxy Dodecanoic | Yes | No | No |
| Acid | | | |
| Octadecanoic (Stearic) | No | Yes | No |
| Acid | | | |
| Methyl Ester | No | Yes | No |
| Octadecanoic Acid | | | |
| Butyrolactone | No | Yes | No |
| Muramic Acid | No | Yes | No |
| Arabinose | No | Yes | No |

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of aging a post-bottled beverage, the method comprising:
adding water to an ultrasound bath;
placing the post-bottled beverage in the ultrasound bath;
wherein the water is at least one inch above the bottom of the bottle of the post-bottled beverage;
applying ultrasonic irradiation to the ultrasound bath at a frequency causing cavitation; and
continuing the application of the ultrasonic irradiation for a duration sufficient for the cavitation to advance the aging process of the post-bottled beverage.

2. The method of claim 1, further comprising:
heating the water.

3. The method of claim 2, wherein the water is heated to a temperature of between 35° C. and 65° C.

4. The method of claim 3, wherein the water is heated to a temperature of approximately 55° C.

5. The method of claim 2 further comprising, cooling the post-bottled beverage after ultrasonic irradiation is complete.

6. The method of claim 1, wherein operating the ultrasound bath includes operating in a sweep mode for at least a portion of the time.

7. The method of claim 6, wherein the duration of the sweep mode is approximately 20 minutes.

8. The method of claim 6, wherein the frequency of the sweep mode is between 35 kHz and 45 kHz.

9. The method of claim 8, wherein the frequency of the sweep mode is approximately 35 kHz.

10. A method of aging a post-bottled alcohol, the method comprising:
adding water to an ultrasound bath;
placing the post-bottled alcohol in the ultrasound bath;
wherein the water is at least one inch above the bottom of the bottle of the post-bottled alcohol;
applying ultrasonic irradiation to the ultrasound bath at a frequency causing cavitation, wherein applying ultrasonic irradiation includes:
operating the ultrasound bath in a pulse mode for approximately two minutes; and
operating the ultrasound bath in a sweep mode:
for approximately twenty minutes; and
at a frequency of between 35 kHz and 45 kHz heating the water to a temperature of between 35° C. and 65° C. while applying ultrasonic irradiation.

11. The method of claim 10, wherein the power of the ultrasound bath is between 120 watts and 150 watts.

12. The method of claim 10, wherein the intensity of the ultrasound bath is at least 1 W/cm squared.

13. A method of treating a post-bottled beverage, the method comprising:
opening the post-bottled beverage;
adding an additive to the post-bottled beverage;
closing the post-bottled beverage;
adding water to an ultrasound bath;
placing the post-bottled beverage in the ultrasound bath;
wherein the water is at least one inch above the bottom of the bottle of the post-bottled beverage;
applying ultrasonic irradiation to the ultrasound bath at a frequency causing cavitation; and
continuing the application of the ultrasonic irradiation for a duration sufficient for the cavitation to advance the aging process of the post-bottled beverage.

14. The method of claim 13, wherein the post-bottled beverage includes a distilled spirit.

15. The method of claim 13, wherein treating the post-bottled beverage includes adding flavoring to the beverage.

16. The method of claim 13, wherein treating the post-bottled beverage includes adding coloring to the beverage.

17. The method of claim 13, wherein adding an additive to the post-bottled beverage includes inserting a bag containing the desired additive.

18. The method of claim 17, wherein the bag contains at least one of:
herbs;
wood pieces;
spices;
saffron;
beets;
cabbage;
paprika;
annatto;
tumeric;
carrot;
black carrot;
radish;
purple sweet potato;
ginger;
extracts;
essential oils;
essences;
distillates;
resins;
gums;
balsams;
juices;
botanical extracts;
flavor;
fragrance;
essential oil;
oleoresin;
essence
extractive;
protein hydrolysate;
distillate;
a product of roasting;
a product of heating;
a product of enzymolysis;
fruit;
fruit juice;
vegetable;
vegetable juice;
edible yeast;
herb;
bark;
bud;
root;
leaf;
plant material;
meat;
seafood;
poultry;
eggs;
dairy products; or
fermentation products.

19. The method of claim 17, wherein the bag is porous.

20. The method of claim 17, further comprising:
opening the post-bottled beverage after ultrasonic irradiation is complete; and removing the bag.
